(19) United States
(12) Patent Application Publication
(10) Pub. No.: US 2010/0293751 A1
(43) Pub. Date: Nov. 25, 2010

(54) HINGE FOR ANCHORING AND AUTOMATIC CLOSING

(75) Inventor: Yung-Chang Chiang, Xizhi City (TW)

Correspondence Address: Ching-Ling Huang, 5597 NW 127th Ter, Portland, OR, 97229, US

(73) Assignee: SINHER TECHNOLOGY INC., Xizhi City (TW)

(21) Appl. No.: 12/471,417

(22) Filed: May 25, 2009

(51) Int. Cl. E05F 1/12; E05D 11/10

(52) U.S. Cl. 16/297; 16/277

(57) ABSTRACT

A hinge provides swiveling of a display relative to one side of a host body includes a first fastening seat, a pintle, a second fastening seat, a main twisting set, a positioning friction plate, an ancillary twisting set, a compressed elastic reed assembly and a nut. The main twisting set has a main rotary member compressed by a returning force of the compressed elastic reed assembly. When the pintle pivots to a selected angle, the protrusion of the main rotary member rapidly slides in a retaining latch trough through a steep sloped surface so that the display can automatically and fully fold over the host body. The main rotary member and the ancillary rotary member turn concurrently and respectively on the steep sloped surface and a gradual sloped surface so that adequate friction resistance is generated due to compression of the returning force of the compressed elastic reed assembly.

### FIELD OF THE INVENTION

The present invention relates to a hinge for electronic products and particularly to a hinge used on notebook computers, personal digital assistants (PDAs), digital cameras, mobile phones or the like to form relative swiveling between a display and a host body.

### BACKGROUND OF THE INVENTION

Conventional electronic products that have a display such as notebook computers, PDAs, digital cameras, mobile phones and the like generally have a hinge to axially couple the display and a host body on two opposite sides thereof. When in use, the display is unfolded relative to the host body. When not in use, the display may be folded over the host body in a closed manner to make stowing and carrying easier.

To fully close the display and the host body after folded, a hook usually is provided to latch the display. For instance, R.O.C. patent No. 506549 discloses an inclined hinge with a torque difference. The hinge has an installation element installed on a metal portion of one side of the body with a metal bearing bent vertically, a swivel portion installed on one side of an opening/closing body and having an installation portion, a larger diameter portion and a deformed smaller diameter portion that are mounted onto the metal bearing so that a pintle can be pivoted about a bearing hole. The pintle is held in a hole formed in the center between the greater diameter portion and one side of the metal bearing. A first friction pad is provided to pivot concurrently with the pintle or stop the metal bearing with a central aperture inserted by the deformed smaller diameter portion. There is a second friction pad fastened to the metal bearing or pivoted concurrently with the pintle. A deformed insert hole is formed in the center of the contact location between the first and second friction pads to hold the deformed smaller diameter portion. One or more than one compression spring washers, discs or undulate blades are provided to form an elastic means. The connection is made when the deformed smaller diameter portion is inserted into a hole formed in the center of the elastic means. A depressing pad is provided to pivot concurrently with the pintle, and driven by the deformed smaller diameter portion, and the pintle has a protrusive side. The metal bearing can generate different friction torques axially on any side due to the pivoting angle of the pintle.

However, during swiveling displacement for closing, it does not provide a hinge of automatic and closed folding of the display over the host body while the pintle is pivoted to a selected angle. It still has drawbacks. To remedy the aforesaid disadvantage, R.O.C. patent No. 411069 entitled “Hinge” provides an adjustment structure with a turning displacement formed between a joined surface of a rotary member and an anchor member. At one selected spot, the rotary member and the anchor member can be latched to form a stageless anchoring and closing without opening or closing the display. By adding a resistance generation structure equipped with a resistance element and a washer, the mutual friction resistance between them also can increase. Hence it provides a steadier stageless anchoring and closing even with a hinge of a smaller diameter. While the R.O.C. patent No. 411069 can provide automatic closing, it still leaves a lot to be desired. More details of its deficiencies are elaborated as follow by referring to FIGS. 1A through 1E and FIG. 2.

FIG. 1A is a fragmentary schematic view of R.O.C. patent No. 411069 and the twisting force curves while it is in consecutive actions. It includes an anchor member 5, a rotary member 6, a resistance generation structure 9 and a returning element 8 interposed between the rotary member 6 and the resistance generation structure 9. The positional relationship of the anchor member 5, rotary member 6, returning element 8 and resistance generation structure 9 shown in FIG. 1A represents a condition of the display fully folded over the host body (not shown in the drawings). Referring to FIG. 2, a conventional opening curve (POP) and closing curve (PCL) start at a spot where the display is fully folded over the host body, the pintle pivots at an angle of 0.degree, and the rotary member 6 is elastically pressed by the returning element 8 and slides automatically in a retaining trough 5a of the anchor member 5 so that a twisting force (or an internal stress, with the twisting force at a scale about 1) is formed on the hinge. When the display is unfolded to form an angle of 5.degrees with the host body (i.e. the pintle pivots to 5.degrees), referring to FIG. 1B, a bulged portion 6a slides out through a sloped surface 5b of the retaining trough 5a, and the retaining trough 5a slides to compress the returning element 8, as a result the twisting force increases rapidly as shown in FIG. 2 by the conventional POP at the angle of 5.degrees. As shown in the drawings, the conventional POP is steep, hence unfolding the display requires a greater force. It means a heavy opening. When the display is opened to form an angle just over 10.degrees with the host body (i.e. the pintle pivots just over 10.degrees), referring to FIG. 1C, the bulged portion 6a has fully slid out of the sloped surface 5b of the retaining trough 5a, and compresses the returning element 8 and passes over a threshold point, as a result a maximum twisting force is formed on the returning element 8 caused by the maximum compression of the bulged portion 6a, then drops drastically as shown in FIG. 2 by the conventional POP at the angle over 10.degrees. Thus during unfolding of the display, the maximum twisting force (at a scale about 8) of the conventional POP of the hinge is quite significant, namely for the conventional display equipped with the automatic closing hinge, unfolding the display needs a greater force. This is the main drawback of the R.O.C. patent No. 411069. As a result, unfolding the display from the host body often requires a user prying with two hands. Otherwise the host body tends to be dragged to the display during the unfolding process. However, after the display has been unfolded to form an angle over 10.degrees with the host body (i.e. the pintle has pivoted over 10.degrees), referring to FIGS. 1D and 1E, the bulged portion 6a has already escaped the sloped surface 5b without continuously compressing the returning element 8, and slides to form a steady twisting force (at a scale about 4.5) as shown in FIG. 2, indicated by the conventional POP. On the other hand, when the display is closed to form an angle with the host body just over 10.degrees (i.e. the pintle pivots just over 10.degrees), referring to FIG. 1C, the bulged portion 6a is compressed by the returning force of the returning element 8, and has just passed over the threshold point and starts to slide into the retaining trough 5a through the sloped surface 5b to return to the position shown in FIG. 1A. Also referring to FIG. 2, then a conventional closing curve (PCL) is formed while the pintle pivots within an angular range between 10.degrees and 0.degree. When the display closes at the selected angle of 10.degrees on the conventional PCL, a steady twisting force (at about a scale of 4.5 against the compressing force of the returning element) is formed to automatically fold the display over the host body to generate a “light closing” result. Consequently, the closed display also receives a smaller depressed force. This is another problem occurred to R.O.C. patent No. 411069.

### SUMMARY OF THE INVENTION

The primary object of the present invention is to provide a hinge that allows a display to automatically and fully fold over a host body when the hinge is swiveled to a pre-set angle during closing displacement of the display and also provide adequate friction resistance to achieve a “light opening and heavy closing” and stageless anchoring effect while the display is unfolded and the pintle pivots within an angular range of ninety degrees.

To achieve the foregoing object, the present invention provides a hinge for anchoring and automatic closing to allow a display to swivel relative to one side of a host body. The hinge according to the invention includes a first fastening seat which has an extended installation end fastened to the host body and an axle support portion. The axle support portion has an axle hole. The first fastening seat also has an anchor notch. The hinge further has a pintle which has a shaft running through the axle hole and a fastening pin, a second fastening seat which has a pin hole to receive the fastening pin and a coupling end fastened to the display, and a main twisting set which is fastened to the first fastening seat and has a main anchor member axially coupled on the pintle and a main rotary member fastened to the pintle. The main rotary member has a protrusion. The main anchor member has a retaining latch trough latchable with the protrusion and a steep sloped surface to facilitate sliding of the protrusion in or out of the retaining latch trough. A positioning friction plate is provided to axially couple on the pintle, and has an anchor end wedged in the anchor notch. There is also an ancillary twisting set which has an ancillary anchor member fixedly located on the positioning friction plate and axially coupled on the pintle and an ancillary rotary member fixedly coupled on the pintle. The ancillary rotary member has a bulged edge. The ancillary anchor member has a gradual sloped surface to allow the bulged edge to slide up or down. A compressed elastic reed assembly is provided to axially couple on the pintle and includes a plurality of arched washers to provide a friction force required by swiveling of the main twisting set and the ancillary twisting set. And a nut is provided to fasten to a distal end of the shaft of the pintle.

By means of the structure set forth above, the main rotary member is compressed by a returning force of the compressed elastic reed assembly. When the pintle pivots to a selected angle, the protrusion of the main rotary member rapidly slides through the steep sloped surface in the retaining latch trough of the main anchor member, and the display automatically and fully folds over the host body in a closed condition. The main rotary member of the main twisting set and the ancillary rotary member of the ancillary twisting set can swivel concurrently and respectively on the steep sloped surface and the gradual sloped surface of different gradients, and are compressed by the returning force of the compressed elastic reed assembly. Thus an adequate friction resistance is generated to form light opening and heavy closing and stageless anchoring for the display during unfolding and the pintle pivoting within the angular range of ninety degrees.

The foregoing, as well as additional objects, features and advantages of the invention will be more readily apparent from the following detailed description, which proceeds with reference to the accompanying drawings.

### BRIEF DESCRIPTION OF THE DRAWINGS

FIGS. 1A through 1E are fragmentary schematic views of a conventional hinge in consecutive unfolding conditions.

FIG. 2 is a chart showing twisting force curves according to FIGS. 1A through 1E.

FIG. 3 is a perspective view of the hinge of the invention.

FIG. 4 is a plane top view according to FIG. 3.

FIG. 5 is an exploded view according to FIG. 3.

FIG. 6 is an exploded view based on another viewing angle according to FIG. 3.

FIGS. 7A through 7E are fragmentary schematic views of the hinge of the invention in consecutive unfolding conditions.

FIG. 8 is a chart showing twisting force curves according to FIGS. 7A through 7E.

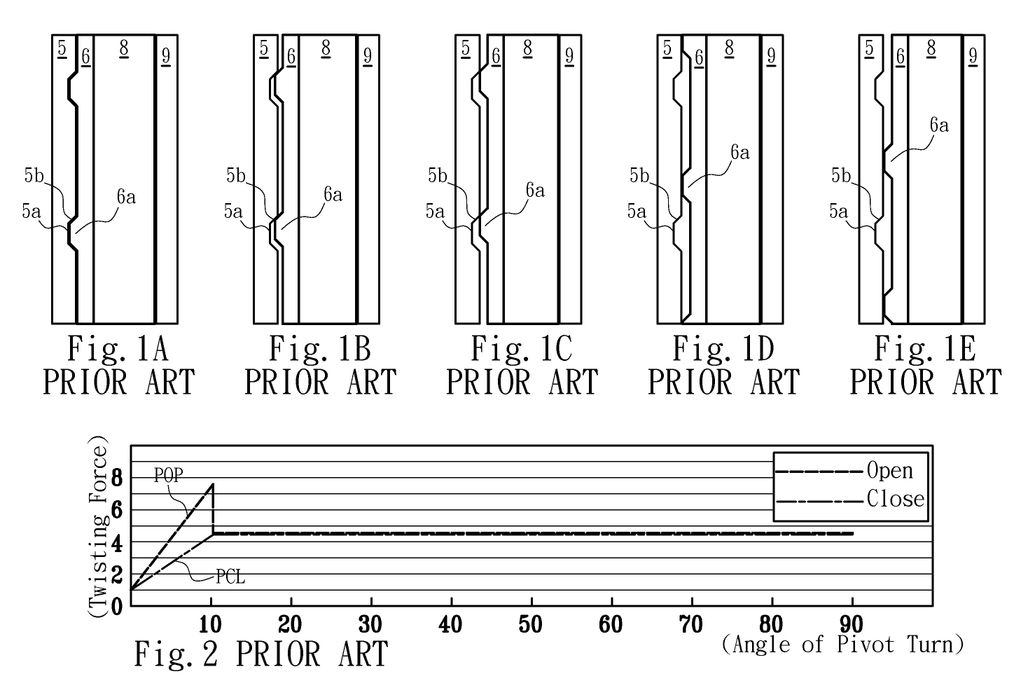

### DETAILED DESCRIPTION OF THE PREFERRED EMBODIMENT

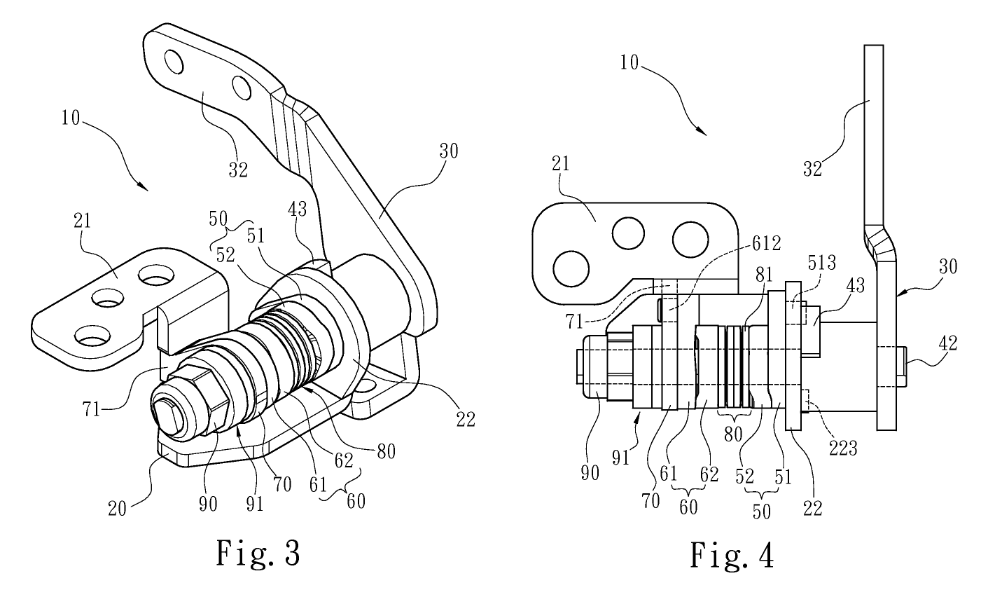

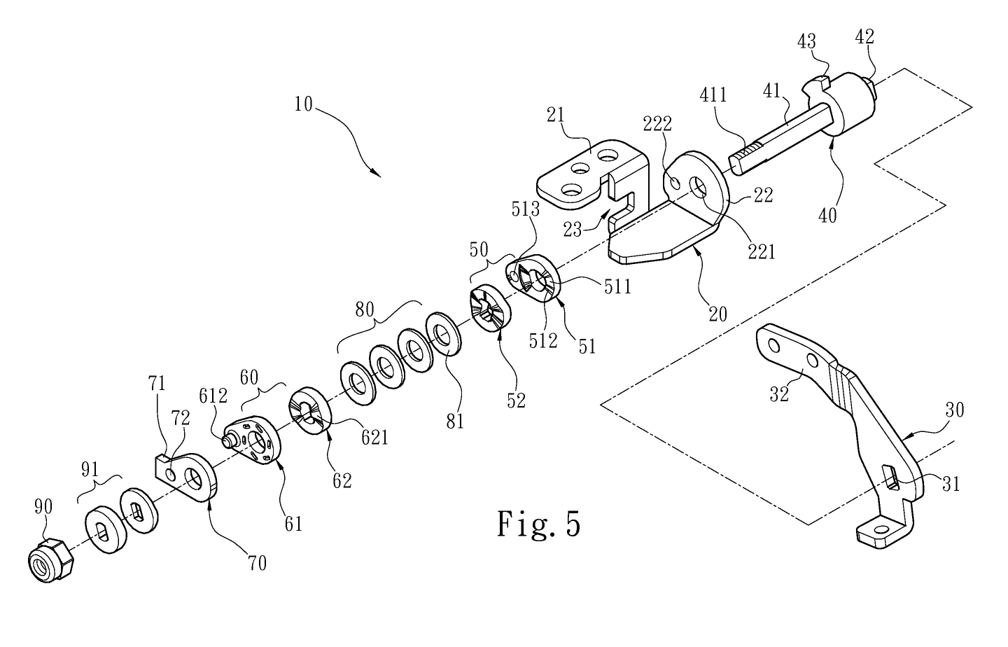

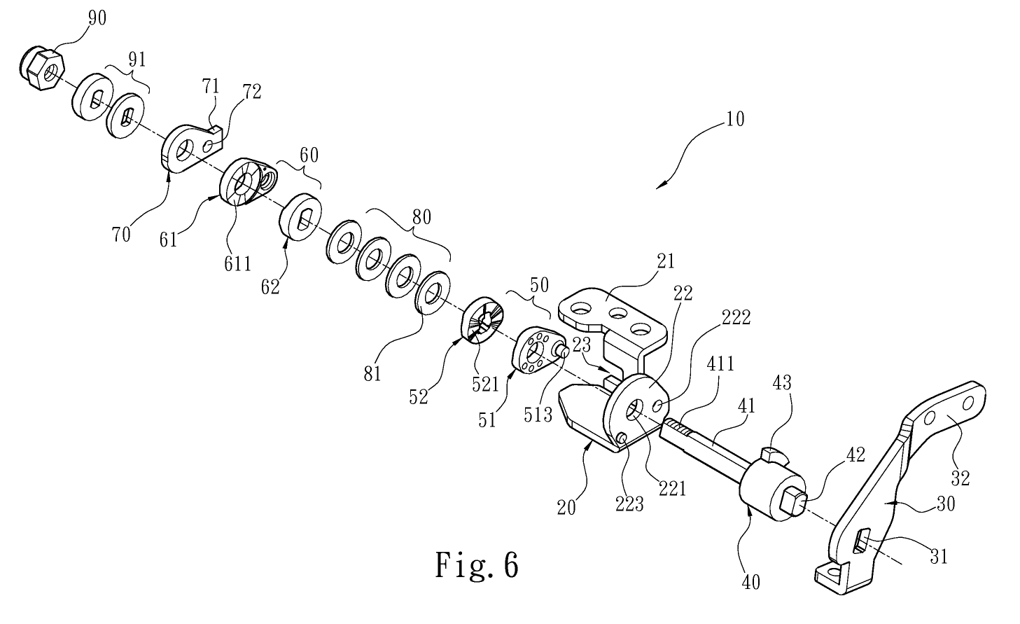

Please refer to FIGS. 3 through 6, the hinge 10 according to the invention aims to form swiveling of a display relative to one side of a host body (their structural relationship and operational principle are known to one skilled in the art, thus the details are omitted in the drawings). The hinge 10 includes a first fastening seat 20 which has an extended installation end 21 fastened to the host body and an axle support portion 22. The axle support portion 22 has an axle hole 221. The first fastening seat 20 further has an anchor notch 23. The axle support portion 22 has an anchor stud 223. The hinge also has a pintle 40 which has a shaft 41 running through the axle hole 221 and a fastening pin 42. The pintle 40 also has a jutting angular anchor lug 43. When the pintle 40 pivots, the angular anchor lug 43 hits the anchor stud 223 or a first anchor pin 54 so that its pivoting stroke is restricted. The shaft 41 of the pintle 40 further has a distal end with a threaded portion 411 formed thereon. The hinge further has a second fastening seat 30 which has a pin hole 31 wedged by the fastening pin 42 and a coupling end 32 fastened to the display, a main twisting set 50 which has a main anchor member 51 fastened to the first fastening seat 20 and axially coupled on the pintle 40 and a main rotary member 52 fixedly coupled on the pintle 40. The main rotary member 52 has a protrusion 521. The main anchor member 51 has a retaining latch trough 511 latchable with the protrusion 521 and a steep sloped surface 512 allowing the protrusion 521 to slide in or out of the retaining latch trough 511. The main anchor member 51 further has a second anchor pin 513. When the pintle 40 pivots, the angular anchor lug 43 hits the second anchor pin 513 so that its pivoting stroke also is confined in another direction. Additionally, the axle support portion 22 of the first fastening seat 20 has an anchor hole 222 inserted by the second anchor pin 513. The hinge further has a positioning friction plate 70 which is axially coupled on the pintle 40 and has an anchor end 71 wedged in the anchor notch 23 and a holding aperture 72, and an ancillary twisting set 60 which has an ancillary anchor member 61 fixedly mounted on the positioning friction plate 70 and axially coupled on the pintle 40 and an ancillary rotary member 62 fixedly coupled on the pintle 40. The ancillary rotary member 62 has a bulged edge 621. The ancillary anchor member 61 has a gradual sloped surface 611 to allow the bulged edge 621 to slide up or down. The ancillary anchor member 61 also has a holding pin 612 wedged in the holding aperture 72. The hinge further has a compressed elastic reed assembly 80 which is axially coupled on the pintle 40 and has a plurality of arched washers 81 to provide a friction force required by swiveling of the main twisting set 50 and the ancillary twisting set 60. The arched washers 81 have at least two arched surfaces facing each other, and preferably four pieces divided into two pairs each with two arched surfaces facing each other. Furthermore, the hinge also has a nut 90 fastened to the threaded portion 411 of the pintle 40. Finally, the ancillary twisting set 60 and the nut 90 may be interposed by at least one friction washer 91 which is fixedly coupled on the pintle 40 to increase friction force of pivoting stroke of the pintle 40 to achieve desired stageless anchoring.

By means of the construction set forth above, the main rotary member 52 is compressed by a returning force of the compressed elastic reed assembly 80. When the pintle 40 pivots to a selected angle, the protrusion 521 rapidly slides through the steep sloped surface 512 in the retaining latch trough 511 of the main anchor member 51 so that the display automatically and fully folds over the host body. The main rotary member 52 and the ancillary rotary member 62 pivot concurrently and respectively on the steep sloped surface 512 and the gradual sloped surface 611, and are compressed by the returning force of the compressed elastic reed assembly 80, thus adequate friction resistance is generated. Therefore, when the display is unfolded and the pintle 40 pivots within an angle of ninety degrees, a light opening and heavy closing and stageless anchoring effect can be accomplished.

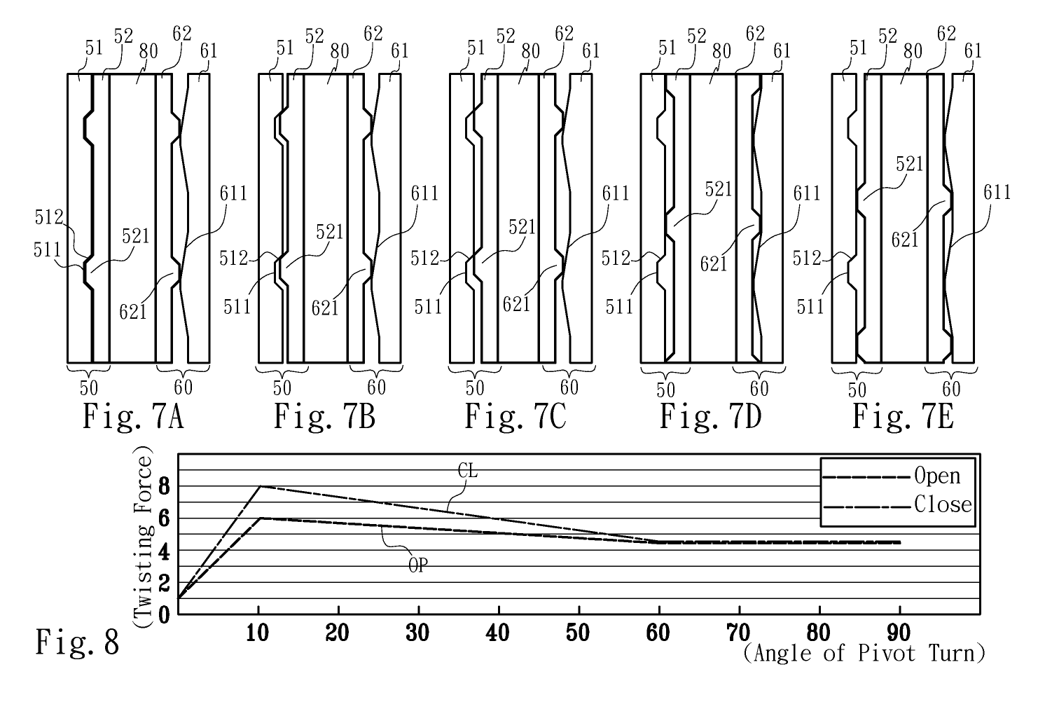

Refer to FIGS. 7A through 7E for the fragmentary consecutive actions of the hinge and FIG. 8 for the corresponding twisting force curves. FIG. 7A illustrates the main anchor member 51 and main rotary member 52 of the main twisting set 50, the ancillary anchor member 61 and ancillary rotary member 62 of the ancillary twisting set 60, and the compressed elastic reed assembly 80 interposed between the main twisting set 50 and the ancillary twisting set 60. Their relative positions represent the fully folding condition of the display over the host body (not shown in the drawings). Also referring to FIG. 8, in the fully folding condition, the opening curve OP and the closing curve CL start at the point where the pivoting angle of 0.degree of the pintle 40, and the hinge 10 has a twisting force (or internal stress, at a scale about 1) resulting from compression of the elastic force of the compressed elastic reed assembly 80 applied to the main rotary member 52 which automatically slid in the retaining latch trough 511 of the main anchor member 51. When the display is unfolded to form an angle of 5.degrees with the host body (i.e. the pintle 40 pivots to the angle of 5.degrees), referring to FIG. 7B, the protrusion 521 slides out from the retaining latch trough 511 through the steep sloped surface 512, meanwhile the bulged edge 621 slides concurrently on the gradual sloped surface 611 in the same direction. As the steep sloped surface 512 has a greater gradient than the gradual sloped surface 611, the protrusion 521 slides out and compresses the compressed elastic reed assembly 80 at a greater distance than the distance caused by the sliding of the bulged edge 621. The gradually increased twisting force (at a scale about 3.5) is formed by the compression of the compressed elastic reed assembly 80 which generated more rapidly by the protrusion 521 and released more slowly by the bulged edge 621. As shown by the opening curve OP at an angle of 5.degrees in FIG. 8. Compared with the conventional POP shown in FIG. 2, the twisting force generated by the hinge 10 of the invention on the opening curve OP is much smaller than the conventional one, thus a “light opening” and “stageless anchoring” effect can be accomplished for the display during unfolding. When the display is unfolded to form an angle just over 10.degress with the host body (i.e. the pintle pivots an angle just over 10.degrees), referring to FIG. 7C, the protrusion 521 fully slides out of the steep sloped surface 512 in the retaining latch trough 511, but the bulged edge 621 still is sliding on the gradual sloped surface 611. As the protrusion 521 just passes over the threshold point to form a maximum compression of the compressed elastic reed assembly 80 while the bulged edge 621 is still slowly proceeding release of the compressed elastic reed assembly 80 to release the twisting force of the hinge 10, the compressed elastic reed assembly 80 forms maximum compression and a maximum twisting force is generated (at a scale about 6). As shown by the opening curve OP at the angle over 10.degrees in FIG. 8, during the unfolding process of the display, the hinge 10 generates a maximum twisting force (at a scale about 6) much smaller than the conventional one (at a scale about 8 as shown in conventional POP in FIG. 2). Thus it proves that the invention can provide the “light opening” and “stageless anchoring” effect while the display is unfolded. When the display is continuously unfolded to form an angle just over 60.degrees with the host body (i.e. the pintle 40 pivots just over 60.degrees), referring to FIG. 7D, the protrusion 521 has escaped from the steep sloped surface 512 and slides without compressing the compressed elastic reed assembly 80, meanwhile the bulged edge 621 just finishes sliding on the gradual sloped surface 611 and passes over another threshold point so that the release of the compressed elastic reed assembly 80 also is finished and a steady twisting force is formed (at a scale about 4.5). As shown by the opening curve OP in FIG. 8 with the angle just exceeding 60.degrees, the display is unfolded at an angle just over 60.degrees, the hinge 10 generates a steady twisting force same as the conventional one (shown by conventional POP in FIG. 2) until the pintle 40 pivots to the angle shown in FIG. 7E.

On the other hand, when the display is folded in the opposite direction to form an angle just over 60.degrees with the host body (i.e. the pintle 40 pivots just over 60.degrees), referring to FIG. 7D, the protrusion 521 remains at a location away from the steep sloped surface 512 and slides without increasing or decreasing compression of the compressed elastic reed assembly 80, meanwhile the bulged edge 621 just passes over another threshold point and slides on the gradual sloped surface 611 so that a slow compression is formed to slowly increase the twisting force. As shown in the closing curve CL in FIG. 8 at an angle over 60.degrees, when the display is folded at an angle just over 60.degrees, the slowly increasing twisting force of the closing curve CL of the hinge 10 is greater than the opening curve OP at the same angular range, and also is greater than the steady twisting force of the conventional closing curve PCL (as shown in FIG. 2), thus a “heavy closing” and “stageless anchoring” effect can be achieved during folding of the display. When the display is folded at an angle just over 10.degrees with the host body (i.e. the pintle 40 pivots just over 10.degrees), referring to FIG. 7C, the protrusion 521, due to compression of the compressed elastic reed assembly 80, starts entering the steep sloped surface 512 of the retaining latch trough 511 and passes over the threshold point to slide on the steep sloped surface 512, meanwhile even though the bulged edge 621 is still simultaneously sliding on the gradual sloped surface 611, due to the protrusion 521 slides quickly in the retaining latch trough 511 under the returning force of the compressed elastic reed assembly 80, the compression force of the compressed elastic reed assembly 80 is released rapidly, thus the condition shown in FIG. 7A is resumed quickly. Referring to FIG. 8, the closing curve CL of the pintle 40 in the angular range between 10.degrees and 0.degree is much steeper than the conventional closing curve PCL (as shown in FIG. 2), thus the steeper closing curve CL line shows a greater twisting force (at a scale about 8, compared with the compression force of the compressed elastic reed assembly 80). As a result, the display can be folded over the host body quicker and securer than the conventional one. In short, adopted the invention, the display can automatically and fully fold over the host body to form a closed condition when the display is folded to a selected angle (such as 10.degrees discussed in the previously example).

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A hinge for anchoring and automatic closing to provide swiveling of a display relative to one side of a host body, comprising:
a first fastening seat which has an axle support portion and an extended installation end fastened to the host body, the axle support portion having an axle hole, and the first fastening seat having an anchor notch;
a pintle which has a shaft run through the axle hole and a fastening pin;
a second fastening seat which has a pin hole inserted by the fastening pin and a coupling end fastened to the display;
a main twisting set which has a main anchor member fixedly located on the first fastening seat and axially coupled on the pintle and a main rotary member fixedly coupled on the pintle, the main rotary member having a protrusion, the main anchor member having a retaining latch trough latchable by the protrusion and a steep sloped surface slidable by the protrusion in or out of the retaining latch trough;
a positioning friction plate which is axially coupled on the pintle and has an anchor end wedged in the anchor notch;
an ancillary twisting set which has an ancillary anchor member fixedly located on the positioning friction plate and axially coupled on the pintle and an ancillary rotary member fixedly coupled on the pintle, the ancillary rotary member having a bulged edge, the ancillary anchor member having a gradual sloped surface slidable by the bulged edge up and down;
a compressed elastic reed assembly which is axially coupled on the pintle and includes a plurality of arched washers to provide a friction force required by swiveling of the main twisting set and the ancillary twisting set; and
a nut fastened to a distal end of the shaft of the pintle;
wherein the main rotary member is compressed by a returning force of the compressed elastic reed assembly and the protrusion rapidly slides through the steep sloped surface in the retaining latch trough when the pintle pivots to a selected angle so that the display automatically and fully folds over the host body; the main rotary member and the ancillary rotary member being pivoted concurrently and respectively on the steep sloped surface and the gradual sloped surface and compressed by the returning force of the compressed elastic reed assembly to generate adequate friction resistance such that the display forms a light opening and heavy closing and stageless anchoring during unfolding while the pintle pivots within an angle of ninety degrees.

2. The hinge of claim 1 further having at least one friction washer interposed between the ancillary twisting set and the nut and fixedly coupled on the pintle.

3. The hinge of claim 2, wherein the arched washers of the compressed elastic reed assembly have at least two arched surfaces facing each other.

4. The hinge of claim 3, wherein the arched washers have four pieces.

5. The hinge of claim 3, wherein the main anchor member has a first anchor pin.

6. The hinge of claim 5, wherein the axle support portion of the first fastening seat has an anchor hole inserted by the first anchor pin.

7. The hinge of claim 6, wherein the axle support portion has an anchor stud.

8. The hinge of claim 7, wherein the pintle has a jutting angular anchor lug to hit the anchor stud or the first anchor pin to limit pivoting stroke while swiveling.

9. The hinge of claim 8, wherein the shaft of the pintle has a distal end which has a threaded portion formed thereon.

10. The hinge of claim 9, wherein the nut is screwed with the threaded portion of the pintle.

11. The hinge of claim 10, wherein the positioning friction plate has a holding aperture.

12. The hinge of claim 11, wherein the ancillary anchor member has a holding pin inserted in the holding aperture.

13. The hinge of claim 2, wherein the main anchor member has a second anchor pin.

14. The hinge of claim 13, wherein the axle support portion of the first fastening seat has an anchor hole inserted by the second anchor pin.

15. The hinge of claim 14, wherein the axle support portion has an anchor stud.

16. The hinge of claim 15, wherein the pintle has a jutting angular anchor lug to hit the anchor stud or the second anchor pin to limit pivoting stroke while swiveling.

17. The hinge of claim 2, wherein the shaft of the pintle has a distal end which has a threaded portion formed thereon.

18. The hinge of claim 17, wherein the nut is screwed with the threaded portion of the pintle.

19. The hinge of claim 2, wherein the positioning friction plate has a holding aperture.

20. The hinge of claim 19, wherein the ancillary anchor member has a holding pin inserted in the holding aperture.
